(19) United States
(12) Patent Application Publication
(10) Pub. No.: US 2022/0149445 A1
(43) Pub. Date: May 12, 2022

(54) SECONDARY BATTERY, BATTERY PACK, ELECTRONIC EQUIPMENT, ELECTRIC TOOL, AND ELECTRIC VEHICLE

(71) Applicant: MURATA MANUFACTURING CO., LTD., Kyoto (JP)

(72) Inventors: Kunio SODEYAMA, Kyoto (JP); Noriaki KOKUBU, Kyoto (JP); Masafumi UMEKAWA, Kyoto (JP); Osamu NAGANUMA, Kyoto (JP); Yoko ENDO, Kyoto (JP); Ming SUN, Kyoto (JP)

(21) Appl. No.: 17/586,139

(22) Filed: Jan. 27, 2022

Related U.S. Application Data
(63) Continuation of application No. PCT/JP2020/018689, filed on May 8, 2020.

(30) Foreign Application Priority Data
Aug. 14, 2019 (JP) 2019-148788

(51) Int. Cl. H01M 10/0587; H01M 50/30; H01M 50/531

(52) U.S. Cl. CPC H01M 10/0587; H01M 50/30; H01M 2220/20; H01M 2220/30; H01M 50/531

(57) ABSTRACT

There is provided a secondary battery in which a positive electrode and a negative electrode are laminated with a separator interposed therebetween, and an electrode winding body having a wound structure, an electrolytic solution, and a positive electrode tab connected to the positive electrode are accommodated in an outer can. An insulator is disposed in proximity to an end on a side of the positive electrode tab of the electrode winding body. The electrode winding body and the insulator each have a center hole. A diameter or size of the center hole of the insulator is larger than a diameter of the center hole of the electrode winding body and is smaller than 1.1 times a width of the positive electrode tab.

### CROSS REFERENCE TO RELATED APPLICATIONS

The present application is a continuation of PCT patent application no. PCT/JP2020/018689, filed on May 8, 2020, which claims priority to Japanese patent application no. JP2019-148788 filed on Aug. 14, 2019, the entire contents of which are being incorporated herein by reference.

### BACKGROUND

The present disclosure generally relates to a secondary battery, a battery pack, electronic equipment, an electric tool, and an electric vehicle.

The use of lithium-ion batteries is expanding to automobiles, machine tools, and the like. Since the batteries of automobiles and machine tools may be damaged by external impact, the impact resistance of the batteries is one of the important factors, and various development studies have been conducted.

### SUMMARY

The present disclosure generally relates to a secondary battery, a battery pack, electronic equipment, an electric tool, and an electric vehicle.

In the conventional battery technology, there is a risk that impact resistance may be low. In a battery element (electrode winding body) produced by a winding device, a raised portion may be caused on a top side of the electrode winding body near a through hole due to slight winding displacement. When the electrode winding body moves inside an outer can due to impact on the battery, the raised portion may collide with the insulating plate on the top side. As a result, a safety valve mechanism may be damaged to malfunction.

Therefore, at least one of the purposes of the present disclosure is to provide a battery that is resistant to external impact.

According to an embodiment of the present disclosure, a second battery is provided. The secondary battery includes a positive electrode and a negative electrode that are laminated with a separator interposed therebetween, an electrode winding body having a wound structure, an electrolytic solution, and a positive electrode tab connected to the positive electrode accommodated in an outer can, in which

an insulator is disposed in proximity to an end on a side of the positive electrode tab of the electrode winding body,

the electrode winding body and the insulator each have a center hole,

the insulator is disposed such that a position of the center hole of the electrode winding body and a position of the center hole of the insulator are aligned coaxially, and

a diameter or size of the center hole of the insulator is larger than a diameter of the center hole of the electrode winding body and is smaller than 1.1 times a width of the positive electrode tab.

According to at least an embodiment of the present disclosure, a battery having high impact resistance, which is convenient for automobiles, machine tools, and the like, can be realized.

It should be understood that the contents of the present disclosure should not be restrictively construed by the effects described as examples in the present description, and additional effects may be further provided.

### BRIEF DESCRIPTION OF THE FIGURES

FIG. 1 is a schematic sectional view of a battery according to an embodiment of the present disclosure.

FIG. 2 is a plan view of an insulator according to an embodiment of the present disclosure.

FIG. 3 is a sectional view of a top side of the battery according to an embodiment of the present disclosure.

FIG. 4 is a graph of the pass rates of an impact test and an overload test according to an embodiment of the present disclosure.

FIGS. 5A to 5C are plan views of an insulator, a non-woven fabric without a center hole, and an integrated body thereof according to an embodiment of the present disclosure.

FIG. 6A is a plan view of a non-woven fabric with a center hole, and FIG. 6B is a plan view of an integrated body in which an insulator and the non-woven fabric in FIG. 6A are bonded together according to an embodiment of the present disclosure.

FIG. 7 is a graph of an OCV failure rate.

FIGS. 8A and 8B are plan views illustrating modification examples of an insulator according to an embodiment of the present disclosure.

FIG. 9 is a connection diagram used for explaining a battery pack as an application example according to an embodiment of the present disclosure.

FIG. 10 is a connection diagram used for explaining an electric tool as an application example according to an embodiment of the present disclosure.

FIG. 11 is a connection diagram used for explaining an unmanned aerial vehicle as an application example according to an embodiment of the present disclosure.

FIG. 12 is a connection diagram used for explaining an electric vehicle as an application example according to an embodiment of the present disclosure.

### DETAILED DESCRIPTION

As described herein, the present disclosure will be described based on examples with reference to the drawings, but the present disclosure is not to be considered limited to the examples, and various numerical values and materials in the examples are considered by way of example.

In an embodiment of the present disclosure, a cylindrical lithium-ion battery will be described as an example of a secondary battery. Of course, a battery other than the lithium-ion battery or a battery having a shape other than a cylindrical shape may be used.

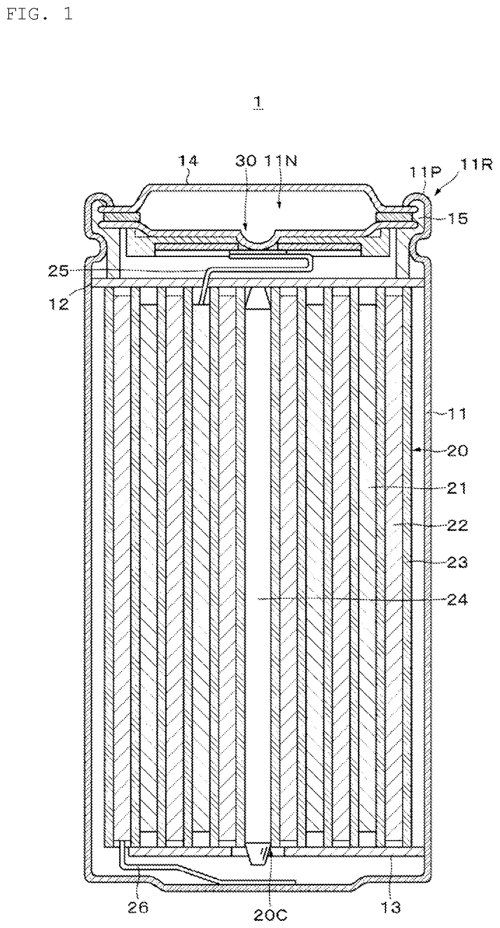

First, an overall configuration of the lithium-ion battery will be described. FIG. 1 is a schematic sectional view of a lithium-ion battery 1. As illustrated in FIG. 1, the lithium-ion battery 1 is a cylindrical lithium-ion battery 1 in which an electrode winding body 20 is housed inside a battery can 11 (outer can).

Specifically, the lithium-ion battery 1 includes a pair of insulators 12, 13 and the electrode winding body 20 inside the cylindrical battery can 11. The lithium-ion battery 1 may further include, for example, any one or more of a thermal resistance (PTC) element, a reinforcing member, and the like inside the battery can 11.

The battery can 11 is a member that mainly houses the electrode winding body 20. The battery can 11 is a cylindrical container whose one end is opened and the other end is closed. That is, the battery can 11 has one end that is opened (open end 11N). The battery can 11 contains any one or more of metal materials such as iron, aluminum, and an alloy thereof. However, any one or more of metal materials, such as nickel, may be plated on a surface of the battery can 11.

The insulators 12, 13 are sheet-shaped members each having a surface substantially perpendicular to a winding axis direction (vertical direction in FIG. 1) of the electrode winding body 20. The insulators 12, 13 are disposed adjacent to the ends of the electrode winding body 20 so as to sandwich together the electrode winding body 20. As the materials of the insulators 12, 13, polyethylene terephthalate (PET), polypropylene (PP), bakelite, or the like is used. The bakelite includes paper bakelite and cloth bakelite that are produced by coating a phenol resin on paper or cloth and then heating it.

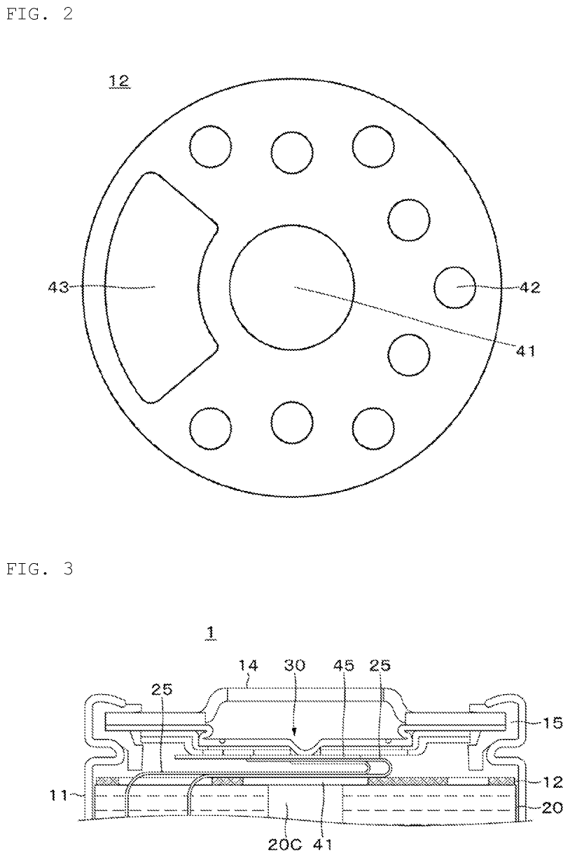

The insulator 12 on the top side (e.g., on the side of the open end 11N of the battery can 11) has a shape as illustrated in FIG. 2. The insulator 12 has a center hole 41 (first hole) and holes 42 (second holes) in a circumferential direction (between the center hole 41 and outer periphery of the insulator 12). These are holes that an electrolytic solution passes through when the electrolytic solution is injected and that a gas passes through when the gas is generated. In the circumferential direction (between the center hole and outer periphery of the insulator), there is also a fan-shaped hole 43 (third hole) opened. This is a hole for extending a positive electrode tab 25 from the electrode winding body 20 side to the safety valve mechanism 30 side (outside). The positive electrode tab 25, the center hole 41 on the top side of the insulator 12, and a center hole 20C of the electrode winding body 20 are disposed below the safety valve mechanism 30. The center hole 41 on the top side of the insulator 12 and the center hole 20C of the electrode winding body 20 are disposed coaxially.

A battery lid 14 and a safety valve mechanism 30 are crimped at the open end 11N of the battery can 11 with a gasket 15 interposed therebetween, thereby forming a crimped structure 11R (crimp structure). As a result, the battery can 11 is sealed in a state in which the electrode winding body 20 and the like are housed inside the battery can 11.

The battery lid 14 is a member that closes the open end 11N of the battery can 11 in the state in which the electrode winding body 20 and the like are housed inside the battery can 11. The battery lid 14 contains the same material as the material for forming the battery can 11. A central region of the battery lid 14 protrudes in the vertical direction in FIG. 1. As a result, a region (peripheral region) other than the central region of the battery lid 14 is in contact with the safety valve mechanism 30 with the PTC element interposed therebetween.

The gasket 15 is a member that by being interposed between the battery can 11 (bent portion 11P) and the battery lid 14, mainly seals a gap between the bent portion 11P and the battery lid 14. However, a surface of the gasket 15 may be coated with, for example, asphalt.

The gasket 15 contains an insulating material. The type of the insulating material is not particularly limited, but is a polymer material such as polybutylene terephthalate (PBT) or polypropyrene (PP). This is because the gap between the bent portion 11P and the battery lid 14 is sufficiently sealed while the battery can 11 and the battery lid 14 are being electrically separated from each other.

The safety valve mechanism 30 is disposed between the battery lid 14 and the positive electrode tab 25, and mainly releases the sealed state of the battery can 11 as necessary when the pressure (internal pressure) inside the battery 11 rises, thereby releasing the internal pressure. The cause of the rise in the internal pressure of the battery can 11 is, for example, a gas generated due to a decomposition reaction of the electrolytic solution during charging and discharging.

In the cylindrical lithium-ion battery, a band-shaped positive electrode 21 and a band-shaped negative electrode 22 are wound in a spiral shape with a separator 23 sandwiched therebetween, which are housed in the battery can 11 in a state of being impregnated with the electrolytic solution. Although not illustrated, in the positive electrode 21 and the negative electrode 22, a positive electrode active material layer and a negative electrode active material layer are formed on one side or both sides of a positive electrode current collector and a negative electrode current collector, respectively. The material of the positive electrode current collector is a metal foil containing aluminum or an aluminum alloy. The material of the negative electrode current collector is a metal foil containing nickel, a nickel alloy, copper, or a copper alloy. The separator 23 is a porous insulating film, which allows movement of lithium ions while electrically insulating the positive electrode 21 and the negative electrode 22.

A space (center hole 20C), created when the positive electrode 21, the negative electrode 22, and the separator 23 are wound, is provided at the center of the electrode winding body 20. A center pin 24 is inserted into the center hole 20C (FIG. 1). However, the center pin 24 can be omitted.

One end of the positive electrode tab 25, for example, is connected to the positive electrode 21, and one end of a negative electrode tab 26, for example, is connected to the negative electrode 22. The positive electrode tab 25 is provided, for example, on the top side of the electrode winding body 20, and contains any one or more of conductive materials such as aluminum. Since the other end of the positive electrode tab 25 is connected to, for example, the safety valve mechanism 30, the positive electrode tab 25 is electrically connected to the battery lid 14.

The negative electrode tab 26 is provided, for example, on the bottom side of the electrode winding body 20 (bottom side of the battery can 11), and contains a conductive material such as nickel. Since the other end of the negative electrode tab 26 is connected to, for example, the battery can 11, the negative electrode tab 26 is electrically connected to the battery can 11.

The detailed configurations and materials of the positive electrode 21, the negative electrode 22, the separator 23, and the electrolytic solution, which are included in the electrode winding body 20, will be described later.

The positive electrode active material layer contains at least a positive electrode material (positive electrode active material) capable of occluding and releasing lithium, and may further contain a positive electrode binder, a positive electrode conductive agent, and the like. The positive electrode material is preferably a lithium-containing compound (e.g., a lithium-containing composite oxide and a lithium-containing phosphoric acid compound).

The lithium-containing composite oxide has, for example, a layered rock salt-type or spinel-type crystal structure. The lithium-containing phosphoric acid compound has, for example, an olivine-type crystal structure.

The positive electrode binder contains a synthetic rubber or a polymer compound. The synthetic rubber is styrene-butadiene rubber, fluorine rubber, ethylene propylene diene, or the like. The polymer compound is polyvinylidene fluoride (PVdF), polyimide, or the like.

The positive electrode conductive agent is a carbon material such as graphite, carbon black, acetylene black, or ketjen black. However, the positive electrode conductive agent may be a metal material or a conductive polymer.

The surface of the negative electrode current collector is preferably roughened. This is because a so-called anchor effect improves the adhesion of the negative electrode active material layer to the negative electrode current collector. Examples of a method of roughening the surface include a method of forming fine particles by using an electrolytic method and providing unevenness on the surface of the negative electrode current collector. A copper foil produced by the electrolytic method is generally called an electrolytic copper foil.

The negative electrode active material layer contains at least a negative electrode material (negative electrode active material) capable of occluding and releasing lithium, and may further contain a negative electrode binder, a negative electrode conductive agent, and the like.

The negative electrode material contains, for example, a carbon material. This is because a change in the crystal structure during occlusion and release of lithium is very small and thus a high energy density can be stably obtained. In addition, a carbon material also functions as a negative electrode conductive agent, so that the conductivity of the negative electrode active material layer is improved.

The carbon material is easily graphitizable carbon, hardly graphitizable carbon, graphite, low crystalline carbon, or amorphous carbon. The shape of the carbon material is fibrous, spherical, granular, or scaly.

In addition, the negative electrode material contains, for example, a metal-based material. Examples of the metal-based material include Li (lithium), Si (silicon), Sn (tin), Al (aluminum), Zr (zinc), and Ti (titanium). The metal-based element forms a compound, mixture, or alloy with another element. Examples thereof include silicon oxide (SiOₓ(0<x≤2)), silicon carbide (SiC) or an alloy of carbon and silicon, and lithium titanate (LTO).

In the lithium-ion battery 1, when an open circuit voltage (i.e., battery voltage) at full charge is 4.25 V or higher, an amount of lithium released per unit mass becomes larger than when the open circuit voltage at full charge is low, if the same positive electrode active material is used. As a result, a high energy density can be obtained.

The separator 23 is a porous film containing a resin, and may be a laminated film of two or more types of porous films. The resin is polypropylene, polyethylene, or the like.

The separator 23 has the porous film as a substrate layer, and may include a resin layer on one or both sides thereof. This is because the adhesion of the separator 23 to each of the positive electrode 21 and the negative electrode 22 is improved and thus a distortion of the electrode winding body 20 is suppressed.

The resin layer contains a resin such as PVdF. When the resin layer is formed, a solution in which the resin is dissolved in an organic solvent is coated on the substrate layer, and then the base material layer is dried. Alternatively, the substrate layer may be immersed in the solution and then the substrate layer may be dried. It is preferable that the resin layer contains inorganic particles or organic particles from the viewpoint of improving heat resistance and battery safety. The types of the inorganic particles are aluminum oxide, aluminum nitride, aluminum hydroxide, magnesium hydroxide, boehmite, talc, silica, mica, and the like. Alternatively, a surface layer containing inorganic particles as a main component, which is formed by a sputtering method, an atomic layer deposition (ALD) method, or the like, may be used, instead of the resin layer.

The electrolytic solution contains a solvent and an electrolyte salt, and may further contain an additive and the like as necessary. The solvent is a non-aqueous solvent such as an organic solvent, or water. An electrolytic solution containing a non-aqueous solvent is called a non-aqueous electrolytic solution. The non-aqueous solvent is a cyclic carbonate ester, a chain carbonate ester, a lactone, a chain carboxylic acid ester or nitrile (mononitrile), or the like.

The electrolyte salt contains, for example, any one or more of salts such as lithium salt. However, the electrolyte salt may contain, for example, a salt other than lithium salt. The salt other than lithium is, for example, a salt of a light metal other than lithium.

A typical example of the electrolyte salt is a lithium salt, but a salt other than the lithium salt may be contained. Examples of the lithium salt include lithium hexafluorophosphate (LiPF₆), lithium tetrafluoroborate (LiBF₄), lithium perchlorate (LiClO₄), lithium methanesulfonate (LiCH₃SO₃), lithium trifluoromethanesulfonate (LiCF₃SO₃), and dilithium hexafluoride silicate (Li₂SF₆). A mixture of these salts can also be used. Among them, it is preferable to use a mixture of LiPF₆ and LiBF₄ from the viewpoint of improving battery characteristics. The content of the electrolyte salt is not particularly limited, but is preferably from 0.3 mol/kg to 3 mol/kg with respect to the solvent.

Next, a method of manufacturing the secondary battery will be described. In producing the positive electrode 21, a positive electrode mixture is first produced by mixing the positive electrode active material, the positive electrode binder, and the positive electrode conductive agent. Subsequently, the positive electrode mixture is dispersed in an organic solvent to produce a positive electrode mixture slurry in a paste form. Subsequently, the positive electrode mixture slurry is coated on both sides of the positive electrode current collector and then dried to form the positive electrode active material layer. Subsequently, the positive electrode active material layer is compression molded using a roll press machine while heating the positive electrode active material layer, thereby obtaining the positive electrode 21.

Also in producing the negative electrode 22, the same procedure as that for the positive electrode 21 described above is performed.

Next, the positive electrode tab 25 and the negative electrode tab 26 are connected to the positive electrode current collector and the negative electrode current collector, respectively, by using a welding method. Subsequently, the positive electrode 21 and the negative electrode 22 are laminated with the separator 23 interposed therebetween, and then they are wound and a fixing tape 31 is attached to an outermost peripheral surface of the separator 23 to form the electrode winding body 20. Subsequently, the center pin 24 is inserted into the center hole 20C of the electrode winding body 20.

Subsequently, the electrode winding body 20 is housed inside the battery can 11 while the electrode winding body 20 is being sandwiched by a pair of insulators. Next, one end of the positive electrode tab 25 is connected to the safety valve mechanism 30 by using a welding method, and one end of the negative electrode tab 26 is connected to the battery can 11.

Subsequently, the battery can 11 is processed by using a beading processing machine (grooving processing machine) to form a recess in the battery can 11. Subsequently, the electrolytic solution is injected into the inside of the battery can 11 to impregnate the electrode winding body 20. Subsequently, the battery lid 14 and the safety valve mechanism 30, together with the gasket 15, are housed inside the battery can 11.

Next, as illustrated in FIG. 1, the battery lid 14 and the safety valve mechanism 30 are crimped with the gasket 15 interposed therebetween at the open end 11N of the battery can 11, thereby forming the crimped structure 11R. Finally, the battery can 11 is closed with the battery lid 14 using a press machine, thereby completing the secondary battery.

### EXAMPLE

Hereinafter, the present disclosure will be specifically described by using the lithium-ion battery 1 produced as described above, based on examples in which the insulator 12 on the top side is tested, or based on examples in which the insulator 12 on the top side to which a non-woven fabric 46 is bonded is tested. It should be understood that the present disclosure is not limited to the examples described below.

As illustrated in FIG. 3, the insulator 12 on the top side was disposed on the electrode winding body 20; the positive electrode tab 25 protruding from the fan-shaped hole 43 of the insulator 12 was disposed on the insulator 12; and the positive electrode tab 25 was connected to the safety valve mechanism 30. A safety valve sub-disk 45 is disposed between the safety valve mechanism 30 and the positive electrode tab 25, and is disposed substantially coaxially with the center hole 20C of the electrode winding body. If a physical impact is directly applied to the safety valve sub-disk 45, the safety valve mechanism 30 malfunctions. The diameter of the center hole 20C of the electrode winding body 20 was set to 3 (mm), the diameter of the safety valve sub-disk 45 was set to 5.35 (mm), and the width of the positive electrode tab 25 was set to 6.4 (mm). The material of the insulator 12 was a PET resin. The shape of the center hole 41 of the insulator 12 was circular.

Batteries 1, in which the insulators 12 on the top side whose center holes respectively had diameters ranging from 2 (mm) to 9 (mm) were disposed, were prepared, and an impact test and an overload test were performed. The impact test was based on the UN 38.3 standard, and a rotating drum type testing machine was used. The battery 1 in which the safety valve mechanism 30 did not work was determined as pass. In the overload tests, the battery 1 was charged and discharged at a current value of 40 (A) to 50 (A), and the case where the battery 1 was not electrically short-circuited was determined as pass, and a pass rate was calculated. The number of the batteries 1 used in the tests is 20 for each test.

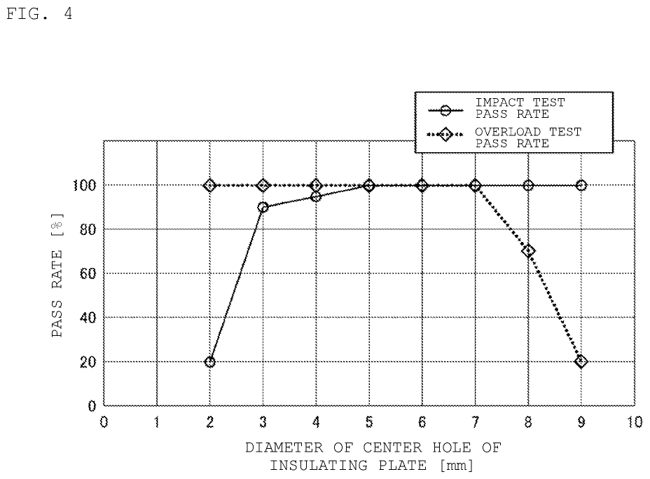

FIG. 4 illustrates the results of the impact test and the overload test. It can be seen that the ranges of high pass rates for both the tests are limited to some diameters of the center hole 41 in the tests. Taking the range in FIG. 4 in which the pass rates of both the tests are 90% or more as an example and taking the range in which either of the pass rates is less than 90% as a comparative example, the diameter of the center hole 41 of the insulator 12 is preferably 3 (mm) to 7 (mm). Three (mm) is equal to the diameter of the center hole 20C of the electrode winding body 20, and 7 (mm) is a size obtained by multiplying the width of the positive electrode tab 25 by 1.1. Therefore, in order for the battery 1 to be resistant to external impact, it can be said that the diameter of the center hole 41 of the insulator 12 is preferably larger than the diameter of the center hole 20C of the electrode winding body 20 and smaller than 1.1 times the width of the positive electrode tab 25.

When the diameter of the center hole of the insulator 12 was larger than 3 (mm), the pass rate of the impact test was high, as illustrated in FIG. 4. It is considered that this is because when the diameter of the center hole of the insulator 12 is larger than the diameter of the center hole of the electrode winding body 20, the raised portion near the center hole of the electrode winding body 20 can avoid collision with the insulator 12 in the impact test (or when an impact is applied to the battery 1 from the outside), the insulator 12 is prevented from colliding with the safety valve sub-disk 45, and the safety valve mechanism 30 hardly malfunctions. In addition, when the diameter of the center hole of the insulator 12 was smaller than 7 (mm), the pass rate of the overload test was high. It is considered that this is because when the diameter of the center hole 41 of the insulator 12 is smaller than 1.1 times the width of the positive electrode tab 25, the heat of the positive electrode tab 25 generated by the current during the overload test can be prevented, by the insulator 12, from being transferred to the electrode winding body 20 in the overload test (or when a relatively large current flows through the battery 1), and a short circuit due to heat fusion of the separator 23 hardly occurs.

Assuming that the range in which the pass rates of both the tests in FIG. 4 are 100% is a more preferred range as an example, the diameter of the center hole 41 of the insulator 12 is more preferably 5 (mm) to 7 (mm). It is considered that this is because the diameter of the center hole 41 of the insulator 12 was as large as or larger than the diameter of the safety valve sub-disk 45, the insulator 12 did not collide with the safety valve sub-disk 45 during the impact test. Since the diameter of the safety valve sub-disk 45 is 5.35 (mm), it can be said that in order to prevent the collision between the insulator 12 and the safety valve sub-disk 45, the diameter of the center hole 41 of the insulator 12 is more preferably larger than the diameter of the safety valve sub-disk 45 and smaller than 1.1 times the width of the positive electrode tab 25. Considering a slight misalignment between the insulator 12 and the safety valve sub-disk 45, it can be said that the diameter of the center hole 41 of the insulator 12 is more preferably larger than 1.03 times the diameter of the safety valve sub-disk (e.g., 5.5 (mm)).

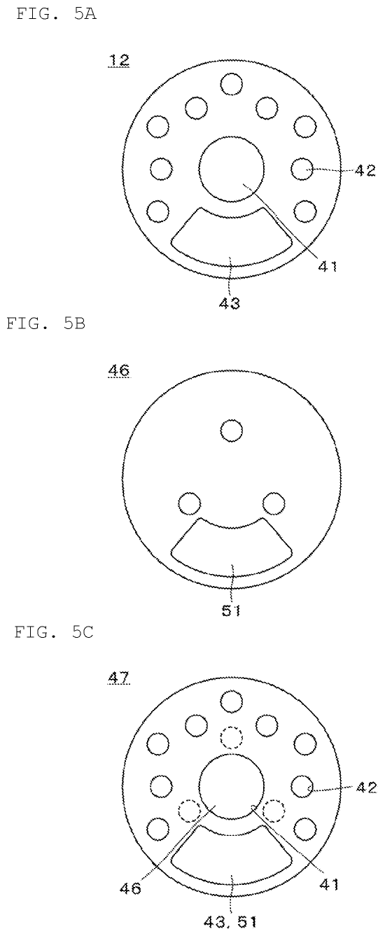

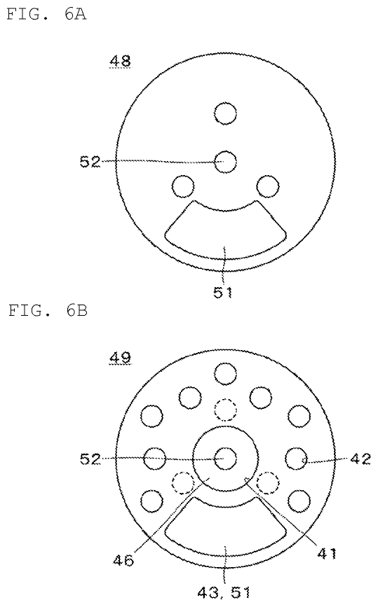

Next, a non-woven fabric 46 (FIG. 5B) having the same size as the insulator 12 on the top side as illustrated in FIG. 5A was prepared. The insulator 12 and the non-woven fabric 46 were bonded together such that the fan-shaped hole 43 of the insulator 12 and a fan-shaped hole 51 of the non-woven fabric 46 overlap at the same position, thereby forming an integrated body 47 as illustrated in FIG. 5C. No center hole was provided in the non-woven fabric 46. The integrated body 47 was disposed at the same position as the insulator 12 of the battery 1 illustrated in FIG. 4, so that the non-woven fabric side of the integrated body 47 faced toward the electrode winding body 20. The non-woven fabric 46 was to be located between the insulator 12 and the electrode winding body 20. As a comparison target of the integrated body 47, an integrated body 49 (FIG. 6B), including a non-woven fabric 48 with a center hole 52 as illustrated in FIG. 6A and the insulator 12, was prepared. OCV failure rate tests were performed on the battery 1 using the integrated body 47 and the battery 1 using the integrated body 49. In the OCV failure rate tests, a battery in which the open end voltage was 1% or more lower than that of the normal battery 1 was determined as OCV failure, and the rate of the OCV failure was determined. The numbers of the batteries used in the tests were each set to 500 (1000 in total).

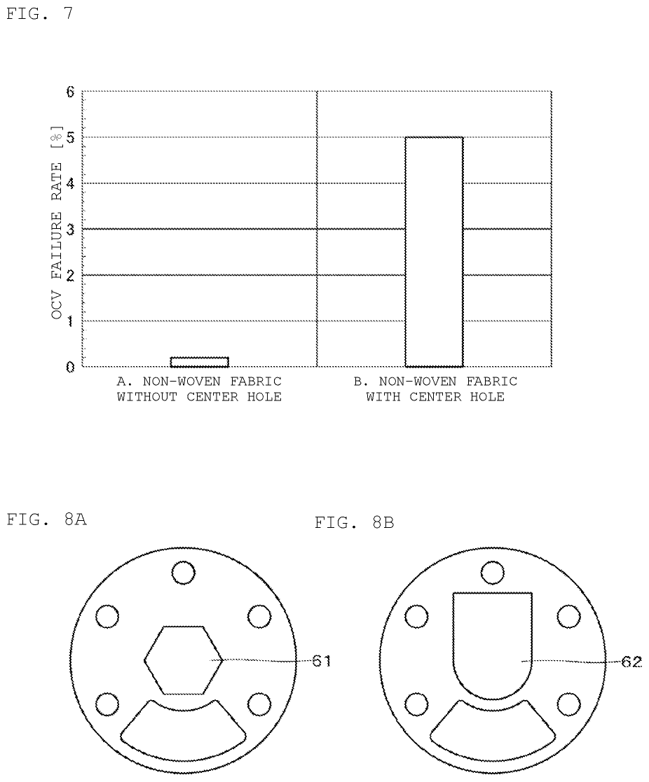

FIG. 7 illustrates the results of the OCV failure rate tests. The OCV failure rate was 0.2% for the case where the non-woven fabric 46 without a center hole was used (A in FIG. 7, integrated body 47), and was 5% for the case where the non-woven fabric 48 with the center hole 52 was used (B in FIG. 7, integrated body 49). From the results in FIG. 7, A in FIG. 7 is more preferable. In other words, it can be said that when the non-woven fabric 46 is disposed between the insulator 12 and the end on the top side of the electrode winding body 20, it is preferable that the non-woven fabric 46 covers the center hole 41 of the insulator 12 and the center hole 20C of the electrode winding body 20.

It is considered that in the case of the non-woven fabric 46 without a center hole, contamination due to metal pieces and the like, possibly occurring when the electrolytic solution was injected, could be prevented by the non-woven fabric 46, so that the OCV failure rate was relatively low.

Although an embodiment of the present disclosure has been specifically described above, the contents of the present disclosure are not limited to the above-described embodiment, and various modifications based on the technical idea of the present disclosure can be made.

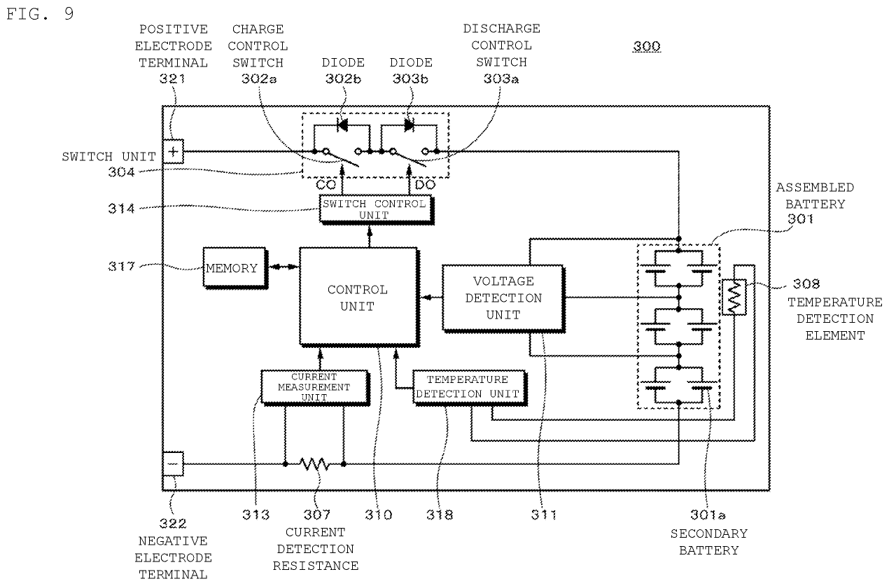

The shape of the center hole on the top side of the insulator 12 is designed to be circular, but the center hole may be a polygonal hole 61 as illustrated in FIG. 8A, it may be a hole 62 having a shape in which a circle and a polygon are combined as illustrated in FIG. 8B, or It may have another shape. The size of the polygonal hole 61 as illustrated in FIG. 8A is the distance between facing vertices. The size of the hole 62 having a shape in which a circle and a polygon are combined as illustrated in FIG. 8B is, for example, the diameter of the semicircle.

The size of the lithium-ion battery 1 is set to 21700, but another size, such as 18650, may be adopted.

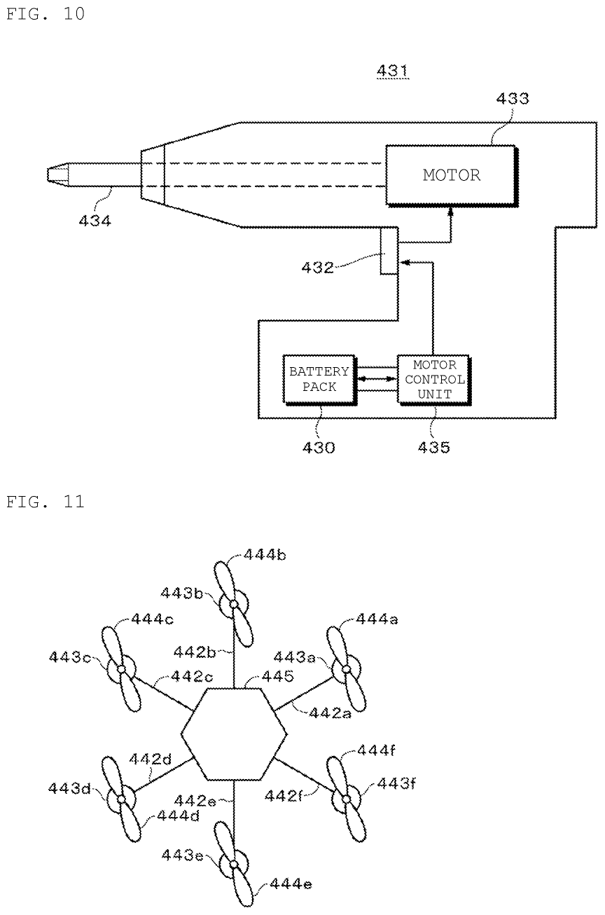

FIG. 9 is a block diagram illustrating a circuit configuration example when the secondary battery according to the embodiment or example of the present disclosure is applied to a battery pack 330. The battery pack 300 includes an assembled battery 301, a switch unit 304 including a charge control switch 302a and a discharge control switch 303a, a current detection resistance 307, a temperature detection element 308, and a control unit (controller) 310. The control unit 310 controls each device, and can further perform charge and discharge control when abnormal heat is generated, and calculate and correct the remaining capacity of the battery pack 300. The control unit (controller) 310 includes at least one of a central processing unit (CPU), a processor or the like.

When the battery pack 300 is charged, a positive electrode terminal 321 and a negative electrode terminal 322 are connected to a positive electrode terminal and a negative electrode terminal of a charger, respectively, and charging is performed. In addition, when electronic equipment connected to the battery pack 300 is used, the positive electrode terminal 321 and the negative electrode terminal 322 are connected to a positive electrode terminal and negative electrode terminal of the electronic equipment, respectively, and discharging is performed.

The assembled battery 301 is formed by connecting a plurality of secondary batteries 301a in series and/or in parallel. In FIG. 9, the case where six secondary batteries 301a are connected in two parallel three series (2P3S) is illustrated as an example, but any connection method may be used.

A temperature detection unit 318 is connected to the temperature detection element 308 (e.g., a thermistor) in order to measure the temperature of the assembled battery 301 or the battery pack 300 and supply the measured temperature to the control unit 310. A voltage detection unit 311 measures the voltages of the assembled battery 301 and each of the secondary batteries 301a constituting the assembled battery 301, and A/D converts the measured voltages to supply to the control unit 310. A current measurement unit 313 measures a current using the current detection resistance 307, and supplies the measured current to the control unit 310.

The switch control unit 314 controls the charge control switch 302a and the discharge control switch 303a of the switch unit 304 based on the voltage and the current input from the voltage detection unit 311 and the current measurement unit 313. When the voltage of any of the secondary batteries 301a becomes equal to or lower than an overcharge detection voltage or an overdischarge detection voltage, or when a large current suddenly flows, the switch control unit 314 prevents overcharge, overdischarge, or overcurrent charge and discharge by sending an off control signal to the switch unit 304.

Here, when the secondary battery is a lithium ion secondary battery, the overcharge detection voltage is defined, for example, as 4.20 V±0.05 V, and the overdischarge detection voltage is defined, for example, as 2.4 V±0.1 V.

After the charge control switch 302a or the discharge control switch 303a is turned off, charging or discharging can be performed only through a diode 302b or a diode 303b. As these charge and discharge switches, semiconductor switches, such as MOSFETs, can be used. In this case, the parasitic diode of the MOSFET functions as the diodes 302b and 303b. It should be understood that the switch unit 304 is provided on the +side in FIG. 9, but it may be provided on the—side.

A memory 317 is composed of a RAM and a ROM, and includes, for example, an erasable programmable read only memory (EPROM) that is a non-volatile memory. The memory 317 stores in advance the numerical values calculated by the control unit 310, the battery characteristics in an initial state of each secondary battery 301a measured at the manufacturing process stage, and the like. The memory 317 can be appropriately rewritten. In addition, by storing the full charge capacity of the secondary battery 301a, the remaining capacity can be calculated in collaboration with the control unit 310.

The secondary battery according to the embodiment or example of the present disclosure described above can be mounted on equipment or device such as electronic equipment, electric transport equipment, and power storage devices in order to be used for supplying power.

Examples of the electronic equipment or device include notebook personal computers, smartphones, tablet terminals, personal digital assistants (PDAs), mobile phones, wearable terminals, video movies, digital still cameras, electronic books, music players, headphones, game machines, pacemakers, hearing aids, electric tools, televisions, lighting equipment, toys, medical equipment, and robots. In addition, the electric transport equipment, the power storage device, the electric tool, and the electric unmanned aerial vehicle, which will be described later, can also be included in the electronic equipment in a broad sense.

Examples of the electric transport equipment or device include electric vehicles (including hybrid vehicles), electric motorcycles, electrically assisted bicycles, electric buses, electric carts, automatic guided vehicles (AGVs), and railway vehicles. Electric passenger aircrafts and electric unmanned aerial vehicles for transportation are also included. The secondary battery according to the present disclosure is used not only as a power supply for driving these, but also as an auxiliary power supply, a power supply for energy regeneration, and the like.

Examples of the power storage device include power storage modules for commercial or household use and power supplies for power storage for buildings such as houses, buildings, and offices or for power generation equipment.

With reference to FIG. 10, an example of an electric screwdriver will be schematically described as an electric tool to which the present disclosure can be applied. An electric screwdriver 431 is provided with a motor 433 that transmits rotational power to a shaft 434 and a trigger switch 432 that a user operates. By operating the trigger switch 432, a screw or the like is driven into an object by the shaft 434.

A battery pack 430 and a motor control unit 435 (motor controller) are housed in a lower case of a handle of the electric screwdriver 431. The battery pack 300 described above can be used as the battery pack 430.

The battery pack 430 is built in the electric screwdriver 431 or is removably provided. The battery pack 430 can be attached to a charging device in a state of being built in or removed from the electric screwdriver 431.

Each of the battery pack 430 and the motor control unit 435 is provided with a microcomputer. Power is supplied to the motor control unit 435 from the battery pack 430, and charge and discharge information on the battery pack 430 is communicated between the microcomputers of the two. The motor control unit (motor controller) 435 controls the rotation/stop and direction of rotation of the motor 433, and can further cut off the power supply to a load (motor 433, etc.) at the time of overdischarge. The motor control unit (motor controller) 435 includes at least one of a microcomputer, a central processing unit (CPU), a processor or the like.

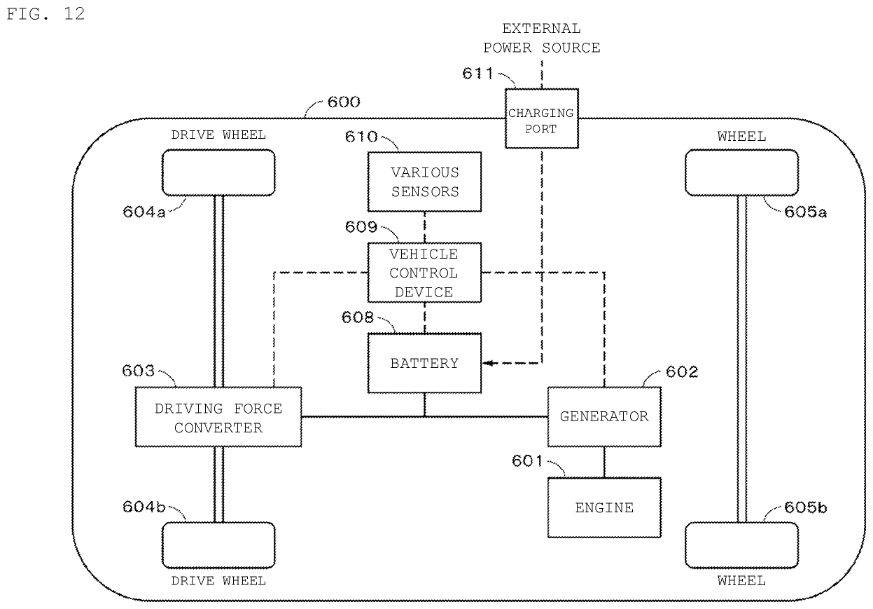

An example in which the present disclosure is applied to a power supply for an electric unmanned aerial vehicle 440 (hereinafter, simply referred to as “drone 440”) will be described with reference to FIG. 11. The airframe of the drone 440 in FIG. 11 includes a cylindrical or rectangular cylindrical body part 441, support shafts 442a to 442f fixed to the upper part of the body part, and a battery part (not illustrated) disposed below the body part. As an example, the body part is designed to have a hexagonal cylindrical shape, and six support shafts 442a to 442f extend radially at equal angular intervals from the center of the body part.

Motors 443a to 443f as power supplies for rotor blades 444a to 444f are attached to the tips of the support shafts 442a to 442f, respectively. A control circuit unit (motor controller) 445 that controls each motor is attached to the upper part of the body part 441. The motor control circuit (motor controller) includes at least one of a central processing unit (CPU), a processor or the like. As the battery unit, the secondary battery or the battery pack 300 according to the present disclosure can be used. The number of the secondary batteries or the battery packs is not limited, but it is preferable that the number of the rotor blades constituting pairs (three in FIG. 11) is made equal to the number of the battery packs. In addition, although not illustrated, a camera may be mounted in the drone 440, or a loading platform capable of carrying a small amount of cargo may be provided therein.

As an example in which the present disclosure is applied to a power storage system for an electric vehicle, FIG. 12 schematically illustrates a configuration example of a hybrid vehicle (HV) adopting a series hybrid system. The series hybrid system is a vehicle that runs on a power driving force converter using the power generated by an engine-powered generator or the power temporarily stored in a battery.

On a hybrid vehicle 600, an engine 601, a generator 602, a power driving force converter (a driving force converter) 603 (DC motor or AC motor; hereinafter simply referred to as “motor 603”), a drive wheel 604a, a drive wheel 604b, a wheel 605a, a wheel 605b, a battery 608, a vehicle control device 609, various sensors 610, and a charging port 611 are mounted. The battery pack 300 of the present disclosure described above or a power storage module on which a plurality of the secondary batteries of the present disclosure are mounted can be applied to the battery 608. The shape of the secondary battery is cylindrical, square, or laminated.

The motor 603 is operated by the power from the battery 608, and the rotational force of the motor 603 is transmitted to the drive wheels 604a, 604b. The rotational force of the engine 601 is transmitted to the generator 602, and the power generated by the generator 602 using the rotational force can be stored in the battery 608. The various sensors 610 control engine speed and the opening degree of a throttle valve (not illustrated) through the vehicle control device 609. The various sensors 610 include a speed sensor, an acceleration sensor, an engine speed sensor, and the like.

When the hybrid vehicle 600 is decelerated by a braking mechanism (not illustrated), a resistance force at the time of the deceleration is applied to the motor 603 as a rotational force, and a regenerative power generated by the rotational force is stored in the battery 608. Although not illustrated, an information processing device (e.g., a battery remaining amount display device) that performs information processing on vehicle control based on information on the secondary battery may also be provided. The battery 608 can receive power supply by being connected to an external power supply with the charging port 611 of the hybrid vehicle 600 interposed therebetween, and can store the power. Such an HV vehicle is called a plug-in hybrid vehicle (PHV or PHEV).

In the above, the series hybrid vehicle has been described as an example, but the present disclosure can also be applied to a parallel system in which an engine and a motor are used in combination, or a hybrid vehicle in which the series system and the parallel system are combined. The present disclosure can further be applied to an electric vehicle (EV or BEV) running only on a drive motor without an engine, and a fuel cell vehicle (FCV).

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery, comprising:
a positive electrode and a negative electrode laminated with a separator interposed therebetween,
an electrode winding body having a wound structure,
an electrolytic solution, and
a positive electrode tab connected to the positive electrode accommodated in an outer can, wherein
an insulator is disposed in proximity to an end on a side of the positive electrode tab of the electrode winding body,
the electrode winding body and the insulator each have a center hole,
the insulator is disposed such that a position of the center hole of the electrode winding body and a position of the center hole of the insulator are aligned coaxially, and
a diameter or size of the center hole of the insulator is larger than a diameter of the center hole of the electrode winding body and is smaller than 1.1 times a width of the positive electrode tab.

2. The secondary battery according to claim 1, wherein
the outer can has an open end,
a battery lid is provided at the open end,
a safety valve mechanism is provided between the battery lid and the positive electrode tab, and
a first end of the positive electrode tab is connected to the positive electrode and a second end of the positive electrode tab is connected to the safety valve mechanism.

3. The secondary battery according to claim 1, wherein
a safety valve sub-disk is provided between the safety valve mechanism and the positive electrode tab, and
the diameter or size of the center hole of the insulator is larger than 1.03 times a diameter of the safety valve sub-disk.

4. The secondary battery according to claim 2, wherein
a safety valve sub-disk is provided between the safety valve mechanism and the positive electrode tab, and
the diameter or size of the center hole of the insulator is larger than 1.03 times a diameter of the safety valve sub-disk.

5. The secondary battery according to claim 1, wherein a non-woven fabric is provided between the insulator and the electrode winding body such that the non-woven fabric overlaps both the center hole of the insulator and the center hole of the electrode winding body.

6. The secondary battery according to claim 1, wherein the center hole of the insulator has a circular shape, a polygonal shape, or a shape in which a circle and a polygon are combined.

7. The secondary battery according to claim 1, wherein the insulator includes PET, PP or bakelite.

8. The secondary battery according to claim 1, wherein one or more second holes are provided between the center hole of the insulator and an outer periphery of the insulator.

9. The secondary battery according to claim 8, wherein the one or more second holes are configured to allow the electrolytic solution or a gas generated inside the electrode winding body to pass through.

10. The secondary battery according to claim 1, wherein
a third hole is provided between the center hole of the insulator and the outer periphery of the insulator, and
the positive electrode tab is designed to extend outward from a side of the electrode winding body through the third hole.

11. The secondary battery according to claim 10, wherein the third hole is fan-shaped.

12. The secondary battery according to claim 1, further comprising a negative electrode tab on a bottom side of the outer can, wherein
a first end of the negative electrode tab is connected to the negative electrode and a second end is connected to the outer can.

13. A battery pack comprising:
the secondary battery according to claim 1;
a controller configured to control the secondary battery; and
an outer body accommodating the secondary battery.

14. An electronic device comprising the secondary battery according to claim 1.

15. An electronic device comprising the battery pack according to claim 13.

16. An electric tool comprising the battery pack according to claim 13 that uses the battery pack as a power supply.

17. An electric vehicle comprising:
the secondary battery according to claim 1; and
a converter that receives supply of power from the secondary battery and converts into a driving force for the electric vehicle.
